(19) United States
(12) Patent Application Publication
(10) Pub. No.: US 2026/0050278 A1
(43) Pub. Date: Feb. 19, 2026

(54) POWER SUPPLY SYSTEM AND METHOD THEREOF FOR POWER SAVING BY DETECTING LOAD

(71) Applicant: LITE-ON TECHNOLOGY CORPORATION, Taipei (TW)

(72) Inventors: Yi-Hsin FENG, Taipei (TW); Bo-Han Li, Taipei (TW); Ting-Yu Hsu, Taipei (TW); Chien-Jung Chiu, Taipei (TW); Ming-Yang Tsai, Taipei (TW)

(21) Appl. No.: 18/942,820

(22) Filed: Nov. 11, 2024

(30) Foreign Application Priority Data
Aug. 15, 2024 (TW) 113130662

(51) Int. Cl. G05F 1/565; G05F 1/56; G05F 1/59

(52) U.S. Cl. CPC G05F 1/565; G05F 1/562; G05F 1/59

(57) ABSTRACT

The present disclosure features a system, method and non-transitory computer readable storage medium thereof for power supply. The method for power supply comprises receiving a first power of a general power supply by a detecting device including a switch set, a connecting port and a controller, and the controller enabling the switch set to operate, to supply a second power of the general power supply to a powered device (PD) through a power supply device (PSE).

This application claims the benefit of Taiwan application Serial No. 113130662, filed Aug. 15, 2024, the disclosure of which is incorporated by reference herein in its entirety.

### TECHNICAL FIELD

The disclosure relates in general to a power supply technologies, and more particularly, to a system, a method, and a non-transitory computer readable storage medium for power supply with a detection function.

### BACKGROUND

In this era of rapid improvement of technologies, techniques related to low power consumption have become important for researching globally, which aims to maintain or improve performance while reducing power consumption, for achieving the purpose of saving energy.

However, the power supply equipment (PSE) of conventional power supply system needs to be operated periodically for keep detecting whether a powered device is connected, which increase the power consumption without load and is against the purpose of saving energy.

Therefore, in order to lower the power consumption of PSE without load, while still being able to detect whether the powered device is connected, there is a need for such techniques in the related industrial field.

### SUMMARY

The present disclosure describes techniques using a detection device for detecting whether a powered device is connected, such the control chip of a power supply equipment, PSE, does not need to keep operating without load (not supplying power to a powered device (PD) or no PD connected), which decreases the power consumption of the PSE without load.

The first aspect of the present disclosure features a power supply system. The power supply system comprises detecting device including a controller, a switch set electrically connected to the controller, and a connecting port electrically connected to the switch set. The detecting device configured to receive a general power supply. The power supply system also comprises a power supply device (PSE) electrically connected to the switch set. Upon determining that a powered device (PD) is connected to the connecting port, the controller enables the switch set to provide the general power supply to the PSE, which the PSE is enabled to supply power to the PD.

The second aspect of the present disclosure features a method for power supply. The method comprises receiving a first power of a general power supply by a detecting device including a switch set, a connecting port and a controller. The method also comprises enabling, by the controller, the switch set to provide the general power supply to a PSE. The method also comprises providing, by the PSE, the general power supply to a PD.

The third aspect of the present disclosure features a method for power supply. The method comprises receiving a first power of a general power supply by a controller including a first pin, a second pin and a third pin, of a detecting device, to turn on the first pin of the controller, which enables the second pin to detect whether a PD is connected. The method also comprises turning off the first pin and turning on the third pin, by the controller, upon determining that a first voltage division of the first power is detected due to the connection of the PD via the second pin, to deliver a second power of the general power supply to a PSE and enable PSE to supply power to the PD.

The fourth aspect of the present disclosure features a non-transitory computer readable storage medium. The non-transitory computer readable storage medium comprises instructions which enables a controller, a computing device or a computer to perform the method for power supply according to the second aspect or the third aspect, of the present disclosure.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a block diagram illustrating an example power supply system, according to one or more implementations of the present disclosure.

FIG. 2 is a diagram illustrating an example detecting device for detecting a powered device (PD) according to one or more implementations of the present application.

FIG. 3 is a diagram illustrating a time diagram for an operation of a controller of the example detecting device of FIG. 2, according to one or more implementations of the present application.

FIG. 4 is a circuit diagram illustrating another example detecting device for detecting the PD, according to one or more implementations of the present application.

FIG. 5 is a flowchart of an example process (method) for detecting the PD, according to one or more implementations of the present application.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

According to the techniques in some implementations of present disclosure, a system and a method for controlling traffic signal are provided.

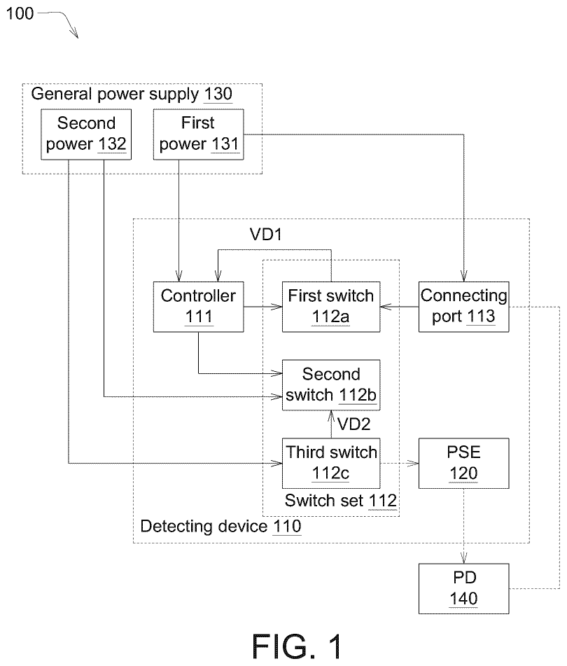

FIG. 1 is a block diagram illustrating an example power supply system 100, according to one or more implementations of the present disclosure. The power supply system 100 comprises a detecting device 110, and a power supply equipment (PSE) 120 electrically connected to the detecting device 110. Additionally, the power supply system 100 is electrically connected to a general power supply 130 and a powered device (PD) 140 externally, which the general power supply 130 includes a first power 131 and a second power 132.

In some implementations, the detecting device 110 detects the PD 140, so that when the PD 140 is connected to the power supply system 100, the detecting device 110 controls the PSE 120 to deliver the general power supply 130 to the PD 140. The general power supply 130 can generate the first power 13 and the second power 132 by an AC-DC converter (not shown) for example. In some implementations, the detecting device 110 turns on or turns off a control IC (control integrated circuit, not shown) of the PSE 120 by detecting the PD 140, to enable the PSE 120 start or stop to supply power to PD 140.

Specifically, the power supply system 100 can be a Power over Ethernet (PoE) system, the PSE 120 can be a PSE of PoE, and the PD 140 can be a PD of PoE. It should be noticed that, in conventional techniques, the PSE of PoE includes a control IC for communicating and detecting whether a PD is connected to a power supply of PoE, to supply power to the PD. Therefore, when the PD is not connected, the control IC of the PSE in conventional techniques still needs to keep operating for detecting whether a PD is connected to the PSE, which increases the power consumption of the PSE without load (not supplying power to the PD). Moreover, since the DoE VII (Department of Energy Level VII) specification, it requires that the power consumption of the PSE with output lower than 49 W should be under 75 mW without load, current power supply equipment products related to PoE cannot comply with the DoE VII specification. Therefore, the power supply system 100 according to the present disclosure can be complied with the DoE VII specification as described in the following implementations.

The detecting device 110 includes a controller 111, a switch set 112 and a connecting port 113. The controller 111 can be a microcontroller unit (MCU) to receive the first power 131 of the general power supply 130. The switch set 112 further comprises a first switch 112a, a second switch 112b and a third switch 112c. The controller 111 is electrically connected to the switch set 112, and the switch set 112 is electrically connected to the connecting port 113. The connecting port 113 can be a RJ45 port.

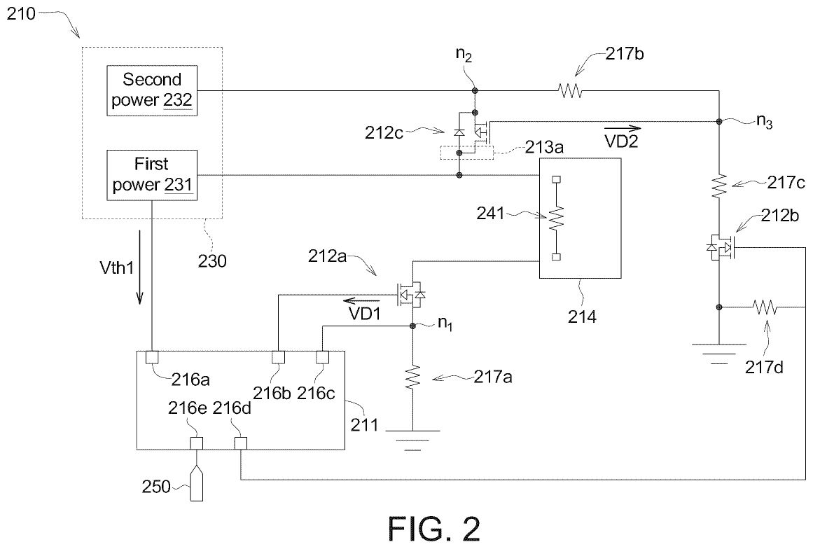

In some implementations, when the PD 140 is connected to the connecting port 113 (for example, when the PD 140 is connected to the connecting port 113, such as an RJ45 port, via a network cable), the connecting port 113 is coupled to a resistance of the PD 140, which enable the controller 111 to detect a first voltage division VD1 of the first power 131 via the first switch 112a. The first voltage division VD1 can be 1.5V. Specifically, when the controller 111 detects the first voltage division VD1, the controller 111 turns off the first switch 112a and turns on the second switch 112b, such that a second voltage division VD2 of the second power 132 is changed to turn on the third switch 112c. In the meantime, the second power 132 supplies power to the PSE 120 via the third switch 112c, such as the second power 132 supplying power to a control IC of the PSE 120 and the control IC delivering the second power 123 to the PD 140. In other Implementations, the PSE 120 at least comprises a voltage regulating circuit or a voltage regulating device for regulating the second power 132 before supplying the second power 132 to the PD 140. The PSE 120 is further electrically connected to the connecting port 113 to supply power to the PD 140 via the connecting port 113. Additionally, the operation mode of the detecting device of the present disclosure will be detailed described referring to FIGS. 2 to 5 as follows.

FIG. 2 is a diagram illustrating an example detecting device 210 for detecting a powered device (PD) according to one or more implementations of the present application. The detecting device 210 is similar to the detecting device 110 of FIG. 1, which comprises a controller 211 for receiving a first power 231 via a power pin 216a. The detecting device 210 also comprises a first switch 212a. In this example, the first switch 212a is an NMOS transistor. A control terminal of the first switch 212a (such as the gate of the NMOS transistor) is coupled to a first pin 216b of the controller 211. A first terminal of the first switch 212a (such as the source of the NMOS transistor) is coupled to a second pin 216c of the controller 211. The detecting device 210 also comprises a connecting port 213 (such as RJ45 port), which a PD (such as the PD 140 of FIG. 1) can be connected to the detecting device 213 and/or a PSE (such as the PSE 120 of FIG. 1) via the connecting port 213. One end of the connecting port 213 is coupled to a second terminal of the first switch 212a (such as the drain terminal of the NMOS transistor). The detecting device 210 also includes a second switch 212b. In this example, the second switch 212b is an NMOS transistor. A control terminal (such as the gate of the NMOS transistor) and a first terminal (such as the source of the NMOS transistor), of the second switch 212b, are coupled to a third pin 216d of the controller 211. The detecting device 210 also includes a third switch 212c. In this example, the third switch 212c is a PMOS transistor. A control terminal (such as the gate of the PMOS transistor) and a first terminal (such as the source of the PMOS transistor), of the third switch 212c, are coupled to the second power 232. A second terminal of the third switch 212c (such as the drain of the PMOS transistor) is coupled to a first power 231 and another end of the connecting port 213. As shown by FIG. 2, the node 213a of the third switch 212c can be coupled to a PSE (such as the PSE 120 of FIG. 1), such as coupled to a control IC of the PSE. In some implementations, the first power 231 and the second power 232 can be different voltages or currents respectively provided by a single general power supply 230, such as generated by an AC/DC converter (such as the first power 431 and the second power 321 of the general power supply 430).

As shown by FIG. 2, the first terminal of the first switch 212a coupled to the second pin 216c of the controller 211 via a first node n1, and the first node n1 is connected to the ground. A first resistor 217a is between the n1 and the ground, which is configured to form a first voltage division VD1 of the first power 231. In some implementations, the resistance of the first resistor 217a is 10 k ohm and the voltage of the first voltage division VD1 is 1.5V. The first terminal of the third switch 212c is coupled to the second terminal of the second switch 212b and the second power 232 via a second node n2. The control terminal of the third switch 212c is coupled to the second terminal of the second switch 212b via a third node n3. A second resistor 217b is between the second node n2 and the third node n3, and a third resistor 217c is between the third node n3 and the second terminal of the second switch 212b. The second resistor 217b and the third resistor 217c are configured to lower a second voltage division VD2 of the second power 232 on the control terminal of the third switch 212c. In some implementations, the resistance of the second resistor 217b is 10 k ohm and the resistance of the third resistor 217c is 100 k ohm.

During the operation, as shown in FIG. 2, when the first power 231 received by the controller 211 is greater than a first threshold Vth1, the controller 211 turns on the first switch 212a via the first pin 216b. When the PD is connected to the connecting port 213, a resistance 241 is formed on the connecting port 213, which the second pin 216c of the controller 211 detects the first voltage division VD1 of the first power 231 via the first switch 212a. In some implementations, the resistance 241 is 24.9 k ohm. When the controller 211 detects the first voltage division VD1, the controller 211 turns off the first switch 212a via the first pin 216b, and turns on the second switch 212b via the third pin 216d, which lowers the second voltage division VD2 of the second power 232 to turn on the third switch 212c via the control terminal of the third switch 212c. In the meantime, the second power 232 supply power to the PSE via the node 213a of the third switch 212c, such as supplying power to the control IC of the PSE for turning on the control IC to deliver second power 232 to the PD by the control IC. The detecting device 210 can include an indicating unit 250 (such as Light-Emitting Diode, LED), which is coupled to a fourth pin 216e of the controller 211 and the PSE (such as PSE 120 of FIG. 1), to inform the controller 211 via the indicating unit 250 after the PSE detecting whether the PD is connected. In some implementations, the PSE coupled to the indicating unit 250 via the connecting port 213, such as RJ 45 port.

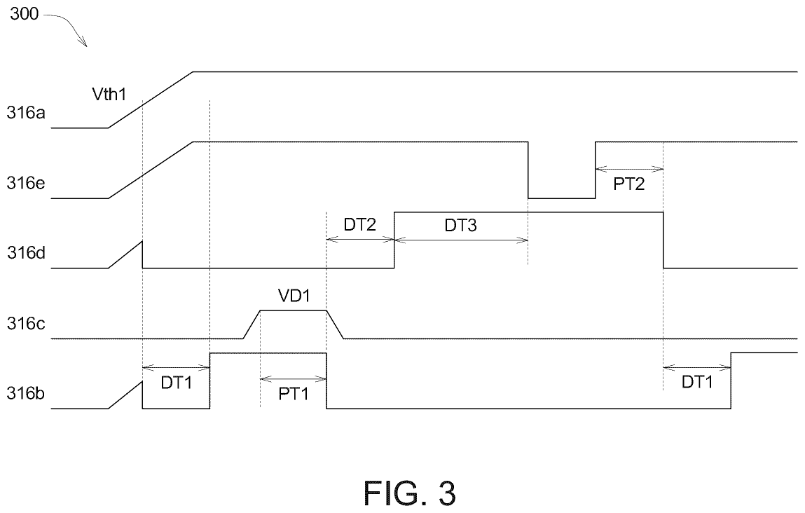

FIG. 3 is a diagram illustrating a time diagram 300 for an operation of a controller of the example detecting device of FIG. 2, according to one or more implementations of the present application. Similarly with the description referring to FIG. 2, as shown by FIG. 3, when the power (such as the first power 231 of FIG. 1) received by the power pin 316a (similar to the power pin 216a of FIG. 2) of the controller of the detecting device (such as the controller 211 of the detecting device 210), is greater than the first Vth1, the first pin 316b (similar to the first pin 216b of the FIG. 2) and the third pin 316d (similar to the third pin 216d of the FIG. 2), of the controller, are reset, and the first pin 316b is turned on after a first delayed time DT1, to turn on, for example, the first switch 212a of FIG. 2. In some implementations, the first delayed time DT1 is 100 ms.

As described referring to FIG. 2, when the PD is connected to the detecting device (such as via the connecting port 213 of FIG. 2), the second pin 316c (similar to the second pin 216c of FIG. 2) of the controller can detect the first voltage division VD1 of the power (such as the first power 231 of FIG. 2), and the first pin 316b is turned off after a first time period PT1, to turn off, for example, the first switch 212a of FIG. 2. In some implementations, the first voltage division VD1 is 1.5V and the first period PT1 is 100 ms. Then, after a second delayed time DT2, the third pin 316d is turned on to activate, for example, the second switch 212b of FIG. 2, thereby turning on, for example, the third switch 212c of FIG. 2, which in turn activates the control IC of the PSE, allowing the PSE to supply power to the PD. In some implementations, the second delayed time DT2 is 100 ms. In the meantime, when the third pin 316d is turned on and after a third delayed time DT3, the controller detects, for example, the action of the indicating unit 250 of FIG. 2 coupled to the fourth pin 316e (similar to the fourth pin 216e of FIG. 2), to indicating whether the PD is connected to the PSE via the indicating unit 250. In some implementations, the third delayed time DT3 is 1 second.

Accordingly, when the PD is connected to the PSE (such as the PD is connected to the PSE via the connecting port 213 of FIG. 2) and after the third delayed time DT3, the fourth pin 316e is switched to the low level, to indicate that the PD is connected to the PSE by the indicating unit 250. Additionally, when the PD is disconnected from the PSE (such as when the PD is removed from the connecting port 213 of FIG. 2), the fourth pin 316e is switched to a high level, and the third pin 316d is turned off after the second period PT2, to turn off, for example, the second switch 212b of FIG. 2, thereby turning off, for example, the third switch 212c of FIG. 2, and turning off the control IC of the PSE, which disables the PSE from supply power to the PD. Then, after the first delayed time, the first pin 316b is turned on to activate, for example, the first switch 212a of FIG. 2, which enables the detecting device to restart and detect whether the PD is connected.

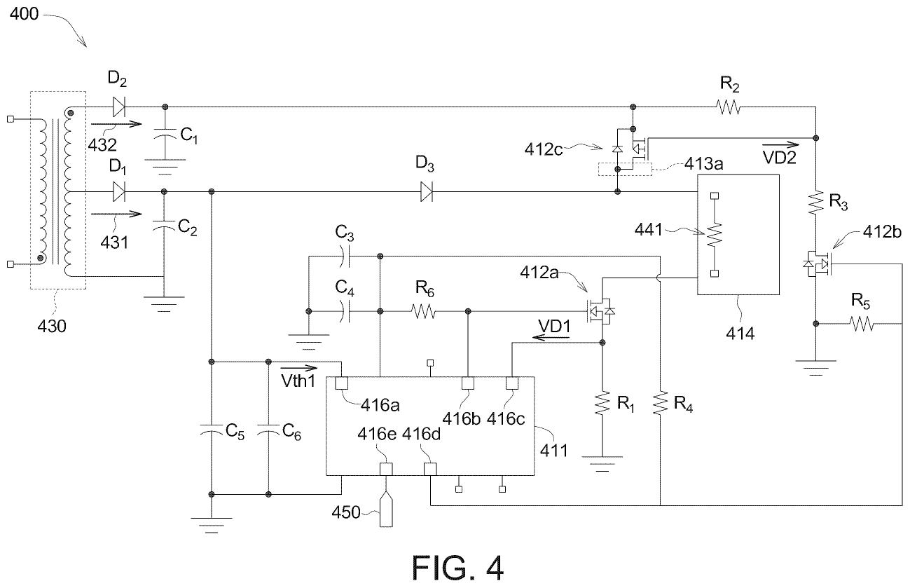

FIG. 4 is a circuit diagram illustrating another example detecting device 410 for detecting the PD, according to one or more implementations of the present application. Similarly to the description referring to FIG. 2, during the operation, when a first power 431 (similar to the first power 231 of FIG. 2) of a general power supply 430 received by a power pin 416a (similar to the power pin 216a of FIG. 2) of the controller 411 (similar to the controller 211 of FIG. 2) is greater than the first threshold Vth1, the controller 411 turns on the first switch 412a (similar to the first switch 212a of FIG. 2) via the first pin 416b (similar to the first pin 216b of FIG. 2). When the PD is connected to the connecting port 413 (similar to the connecting port 213 of FIG. 2), a resistance 441 (such as the resistance 241, for example, being 24.9 k ohm) is formed on the connecting port 413, which the second pin 416c (similar to the second pin 216c of FIG. 2) of the controller 411 detects the first voltage division VD1, such as 1.5V, of the first power 431 via the first switch 412a. The first voltage division VD1 of the first power 413 is formed by a first resistor R₁. When the controller 411 detects the first voltage division VD1, the controller 411 turns off the first switch 412a via the first pin 416b, and turns on the second switch 412b (similar to the second switch 212b of FIG. 2) via the third pin 416d (similar to the third pin 216d of FIG. 2), which lowers the second voltage division VD2 of the second power 432 (similar to the second power 232 of FIG. 2) of the general power supply 430 to turn on the third switch 412c (similar to the third switch 212c of FIG. 2) via the control terminal of the third switch 412c. In the meantime, the second power 432 supplies power to the PSE via the node 413a of the third switch 412c, such as supplying power to the control IC of the PSE for turning on the control IC to deliver second power 432 to the PD by the control IC. The second resistor R₂ and the third resistor R₃ are configured to lower the second voltage division VD2 of the second power 432. The detecting device 410 can include an indicating unit 450 (similar to the indication unit 250 of FIG. 2), which is coupled to a fourth pin 416e (such as the fourth pin 216e of FIG. 2) of the controller 411, to indicate whether the PD is connected to the PSE (such as the PSE 120 of FIG. 1). Other elements of the detecting device 410 of FIG. 4, such as the first capacitor C₁, the second capacitor C₂, the third capacitor C₃, the fourth capacitor C₄, the fifth capacitor C₅, the sixth capacitor C₆, the fifth resistor Rs, the sixth resistor R₆, a first diode D₁, a second diode D₂ or the third diode D₃, are configured to achieve the foresaid functions, which are not described individually herein.

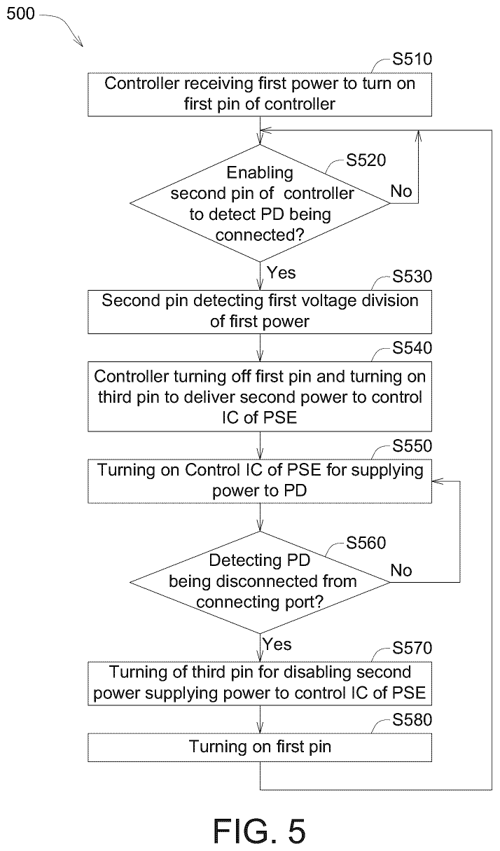

FIG. 5 is a flowchart of an example process (method) 500 for detecting the PD, according to one or more implementations of the present application. In step S510, the controller (such as the controller 111, 211 or 411 of FIG. 1, FIG. 2 or FIG. 4) receives a first power (such as the first power 131, 231 or 431 of FIG. 1, FIG. 2 or FIG. 4), to turn on a first pin (such as the first pin 216b, 316b or 416b of FIGS. 2 to 4) of the controller.

When the first pin of the controller is turned on, then in step S520, the second pin (such as the second pin 216c, 316c or 416c of FIGS. 2 to 4) of the controller is enabled to detect whether a PD is connected. When no PD is connected, it continues to detect whether a PD is connected (step S520). When the PD is connected, in step S530, the second pin detects a first voltage division of a first power (such as the first voltage division VD1 of FIGS. 1 to 4). In step S540, the controller turns off the first pin and turns on the third pin (such as the third pin 216d, 316d or 416d of FIGS. 1 to 4), to deliver a second power (such as the second power 132, 232 or 432 of FIG. 1, 2 or 4) to a control IC of the PSE. In step S550, the control IC of the PSE is turned on to supply power to the PD. In step S560, the controller detects the action of an indicating unit (such as the indicating unit 250 or 450 of FIG. 2 or 4) via the fourth pin (such as the fourth pin 216e, 316e or 416e of FIGS. 2 to 4), to determine whether the PD is disconnected from the connecting port. If the PD keeps connecting to the connecting port, the control IC is keep turning on, which the PSE keeps supplying power to the PD (step S550). When the PD is disconnected from the connecting port, in step S570, the controller turns off the third pin, which disables the second power to supply power to the control CI of the PSE. Then, in step S580, the first pin is turned on, which the second pin of the control restarts to detect whether the PD is connected (step S520).

Accordingly, by the techniques using a detection device for detecting whether a PD, such as PD of PoE, is connected, provided by the present disclosure, the control IC of the PSE is turned on after the PD connected. In other words, the control IC of the PSE is turned off when the PD is disconnected. Therefore, the control IC of the PSE does not need to keep operating without load (not supplying power to a powered device (PD) or no PD connected). For example, by applying the techniques using a detection device for detecting whether a PD of PoE is connected, provided by the present disclosure, the power consumption of the PSE without load can be significantly lower than that of conventional techniques which use the control IC of PSE for detecting whether a PD of PoE is connected. Therefore, the PSE can be complied with DoE VII specification. For example, the power consumption of the PSE with output lower than 49 W, applied with the technique of the present disclosure is lower than 75 mW without load.

The switch elements (switch set or switch), such as PMOS or NMOS transistor, regarding the use of these transistors, can be replaced with each other, arbitrarily combined, or the types of transistors can be changed to achieve equivalent functions. They are not limited to the transistor types or combinations described in the implementations of the present disclosure.

The disclosed and other examples can be implemented as one or more computer program products, for example, one or more modules of computer program instructions encoded on a computer readable medium for execution by, or to control the operation of, data processing apparatus. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed. It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A power supply system, comprising:
a detecting device, including a controller, a switch set electrically connected to the controller, and a connecting port electrically connected to the switch set, the detecting device configured to receive a general power supply; and
a power supply device (PSE), electrically connected to the switch set,
wherein upon determining that a powered device (PD) is connected to the connecting port, the controller enables the switch set to provide the general power supply to the PSE, which the PSE is enabled to supply power to the PD.

2. The power supply system of claim 1, wherein the controller is electrically connected to the general power supply for receiving a first power of the general power supply,
wherein the connecting port includes a first end and a second end correspondingly.

3. The power supply system of claim 2, wherein the switch set further comprises:
a first switch, respectively electrically connected to the controller and the first end of the connecting port, wherein the controller is configured to control the first switch;
a second switch, electrically connected to the controller; and
a third switch, electrically connected to the second switch, the second end of the connecting port, the PSE, and the first power and a second power of the general power supply,
wherein upon determining that a resistance of the PD is electrically connected to the first end and the second end of the connecting port, the controller detects a first voltage division of the first power via the first switch, turns off the first switch and turns on the second switch, to turn on the third switch via the second switch, such the second power is provided to the PSE via the third switch and the PSE supplies power to the PD.

4. The power supply system of claim 3, wherein upon determining that the first power received by the controller is greater than a first threshold, the controller enables the first switch to turn on.

5. The power supply system of claim 3, wherein the third switch comprises a control terminal, a first terminal and a second terminal, wherein the control terminal and the first terminal of the third switch are electrically connected to the second switch and the second power, and the second terminal of the third switch is electrically connected to the first power, the second end of the connecting port and the PSE.

6. The power supply system of claim 3, wherein upon determining that the first power received by the controller is greater than a first threshold, the controller enables the first switch to turn on after a first delayed time,
wherein upon determining that the controller detects the first voltage division of the first power for a first time period, the controller turns off the first switch and, after a second delayed time, turns on the second switch.

7. The power supply system of claim 3, wherein upon determining that the PD is electrically disconnected to the connecting port, the controller turns off the second switch after a second time period, and turns on the first switch after a first delayed time.

8. The power supply system of claim 1, wherein the detecting device further comprises an indicating unit coupled to the controller, and configured to indicate whether the PD is connected to the PSE.

9. A method for power supply, comprising:
receiving a first power of a general power supply by a detecting device including a switch set, a connecting port and a controller;
enabling, by the controller, the switch set to provide the general power supply to a PSE; and
providing, by the PSE, the general power supply to a PD.

10. The method for power supply of claim 9, further comprising:
receiving, by the controller, a first power of the general power supply, and turning on a first switch of the switch set by the controller;
detecting, by the controller, a first voltage division of the first power via the first switch upon determining that a resistance of the PD is electrically connected to the connecting port; and
turning off the first switch and turning on a second switch, by the controller, to turn on a third switch via the second switch, such a second power of the general power supply is provided to the PSE via the third switch and the PSE supplies power to the PD.

11. The method for power supply of claim 10, further comprising turning on, by the controller, the first switch upon determining that the first power received by the controller is greater than a first threshold.

12. The method for power supply of claim 10, further comprising:
turning on, by the controller, the first switch after a first delayed time upon determining that the first power received by the controller is greater than a first threshold; and
turning off the first switch and, after a second delayed time, turning on the second switch, by the controller, upon determining that the first power detects the first voltage division of the first power for a first time period.

13. The method for power supply of claim 10, further comprising:
turning off the second switch after a second time period and turning on the first switch after a first delayed time, by the controller, upon determining that the PD is electrically disconnected to the connecting port.

14. The method for power supply of claim 10, further comprising indicating, by an indicating unit of the detecting device, whether the PD is connected to the PSE.

15. A method for power supply, comprising:
receiving a first power of a general power supply by a controller including a first pin, a second pin and a third pin, of a detecting device, to turn on the first pin of the controller, which enables the second pin to detect whether a PD is connected; and
turning off the first pin and turning on the third pin, by the controller, upon determining that a first voltage division of the first power is detected due to the connection of the PD via the second pin, to deliver a second power of the general power supply to a PSE and enable PSE to supply power to the PD.

16. The method for power supply of claim 15, further comprising turning on the first pin of the controller upon determining that the first power received by the controller is greater than a first threshold.

17. The method for power supply of claim 15, further comprising:
resetting, by the controller, the first pin and the third pin upon determining that the first power received by the controller is greater than a first threshold, wherein the first pin is turned on after a first delayed time; and
turning off the first pin and, after a second delayed time, turning on the third pin, by the controller, upon determining that the first power detects the first voltage division of the first power for a first period, to deliver the second power to the PSE.

18. The method for power supply of claim 15, further comprising:
turning off, by the controller, the third pin after a second period, upon determining that the PD is electrically disconnected, to electrically disconnect the second power and the PSE, which turns off the PSE; and
turning on, by the controller, the first pin after a first delayed time, to re-enable the second pin to detect whether the PD is connected.

19. The method for power supply of claim 15, further comprising indicating, by an indicating unit of the detecting device, coupled to a fourth pin of the controller and the PSE, whether the PD is connected to the PSE.
